(19) United States
(12) Patent Application Publication
(10) Pub. No.: US 2011/0191611 A1
(43) Pub. Date: Aug. 4, 2011

(54) MOBILE COMMUNICATION TERMINAL AND METHOD FOR DISPLAYING ICONS ON DISPLAY OF MOBILE COMMUNICATION TERMINAL

(75) Inventors: Marvin boni ang gaw go, Tokyo (JP); Natsuki Nose, Saitama-ken (JP); Kentaro Takeda, Tokyo (JP)

(73) Assignee: KABUSHIKI KAISHA TOSHIBA, Tokyo (JP)

(21) Appl. No.: 12/851,613

(22) Filed: Aug. 6, 2010

(30) Foreign Application Priority Data
Jan. 29, 2010 (JP) P2010-19621

(51) Int. Cl. G06F 3/048; G06F 1/32

(52) U.S. Cl. 713/320; 715/835

(57) ABSTRACT

A mobile communication terminal configured to run a plurality of application programs is provided, which includes an operation section configured to be operated by a user, a display section configured to display a plurality of icons individually corresponding to the respective programs, a first memory in which a history of use of the programs can be stored, a second memory in which an arrangement of the icons displayed on the display section can be stored, an updating section configured to update the arrangement of the icons stored in the second memory on the basis of the history of use of the programs stored in the first memory, and a display controller configured to display the icons on the display section in accordance with the arrangement stored in the second memory upon the operation section being operated by the user in a specific manner.

### CROSS REFERENCE TO RELATED APPLICATIONS

This application is based upon and claims the benefit of priority from the prior Japanese Patent Application No. 2010-19621 filed on Jan. 29, 2010; the entire contents of which are incorporated herein by reference.

### FIELD

Embodiments described herein relate generally to a mobile communication terminal such as a mobile phone or a PDA (Personal Digital Assistant).

### BACKGROUND

It is generally known that a mobile phone has various functions in addition to voice communication, such as functions of directory management, sending and receiving emails, Web browsing, multimedia reproduction, a digital still camera and a GPS (Global Positioning System) receiver. The mobile phone is equipped with hardware and application software adapted for those functions, and a user can choose a program included in the application software at will, so that a pertinent one of the functions can be implemented.

Further, lots of icons corresponding to the application software programs, electronic files produced by means of the programs and URLs (Uniform Resource Locators) in the Web, etc. are arranged and displayed on a screen, and the user chooses one of these icons, so that one of the application software programs is activated, one of the electronic files is opened after an application software program corresponding to the electronic file is activated, and a Website corresponding to the URL is accessed after a browser software program is activated.

If the number of displayed icons increases, however, it is not always the case that only frequently used icons are displayed. Although the icons can be rearranged in any order as set by the user, there is a problem in that it is inconvenient for the user to rearrange the icons every time as the frequency of use dynamically changes.

Incidentally, it is ordinarily known that some menu table for displaying a list of application software programs is configured to rearrange the displaying order on the table in accordance with the frequency of use.

### BRIEF DESCRIPTION OF THE DRAWINGS

FIG. 1 is a circuit block diagram for illustrating a configuration of a mobile communication terminal of an embodiment of the present invention.

FIG. 2 illustrates an exemplary icon arrangement ordinarily displayed on the mobile communication terminal shown in FIG. 1.

FIG. 3 illustrates an example of use history data 50c shown in FIG. 1.

FIG. 4 illustrates another example of the use history data 50c shown in FIG. 1.

FIG. 5 illustrates yet another example of the use history data 50c shown in FIG. 1.

FIG. 6 illustrates an example of overall rating data 50d shown in FIG. 1.

FIG. 7 illustrates an example of last use history data 50f shown in FIG. 1.

FIG. 8 is a flowchart for illustrating a recommended display control procedure of the mobile communication terminal shown in FIG. 1.

FIG. 9 is a flowchart for illustrating a database updating process of the recommended display control shown in FIG. 8.

FIG. 10 is a flowchart for illustrating a recommended display process depending on the recommended display control shown in FIG. 8.

FIG. 11 illustrates an exemplary recommended display depending on the recommended display control shown in FIG. 10.

FIG. 12 illustrates another exemplary recommended display depending on the recommended display control shown in FIG. 10.

FIG. 13 is a flowchart for illustrating a process for notifying of an update of the recommended display shown in FIG. 10.

### DETAILED DESCRIPTION

According to an embodiment, a mobile communication terminal configured to run a plurality of application programs is provided, which includes an operation section configured to be operated by a user, a display section configured to display a plurality of icons individually corresponding to the respective programs, a first memory in which a history of use of the programs can be stored, a second memory in which an arrangement of the icons displayed on the display section can be stored, an updating section configured to update the arrangement of the icons stored in the second memory on the basis of the history of use of the programs stored in the first memory, and a display controller configured to display the icons on the display section in accordance with the arrangement stored in the second memory upon the operation section being operated by the user in a specific manner.

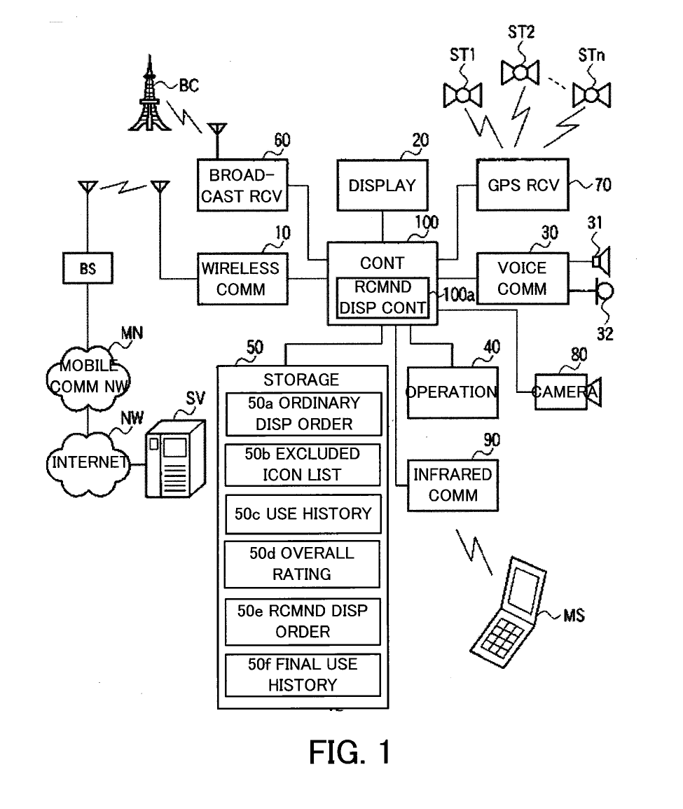

An embodiment of the invention will be explained hereafter with reference to the drawings. FIG. 1 is a block diagram for showing a configuration of a mobile communication terminal of the embodiment of the invention. A mobile phone of a multifunction type, so called a smartphone, will be explained hereafter as an example of the mobile communication terminal.

As shown in FIG. 1, the mobile communication terminal has a controller 100, a wireless communication section 10, a display section 20, a voice communication section 30, an operation section 40, a storage section 50, a broadcast receiving section 60, a GPS receiving section 70, a digital still camera 80 and an infrared ray communication section 90 as main components. The mobile communication terminal has a communication function for performing voice or data communication via a base station BS and a mobile communication network MN, a broadcast receiving function for receiving a digital terrestrial broadcasting signal from a broadcast station BC, a positioning function for determining the own position, an infrared communication function for communication with another mobile phone MS by means of infrared rays, etc. as main functions. The mobile communication terminal has a function for running application software programs which use the main functions, as well. The mobile communication terminal has a function for credit settlement by means of Bluetooth (registered trademark) or short-range wireless communication of a contactless type, an electronic money function for paying for a train or bus ride or shopping, etc. as well.

The wireless communication section 10 performs wireless communication with the base station BS included in the mobile communication network MN as directed by the controller 100. The wireless communication section 10 thereby sends and receives voice data, email data, etc. and receives Web data, streaming data, etc.

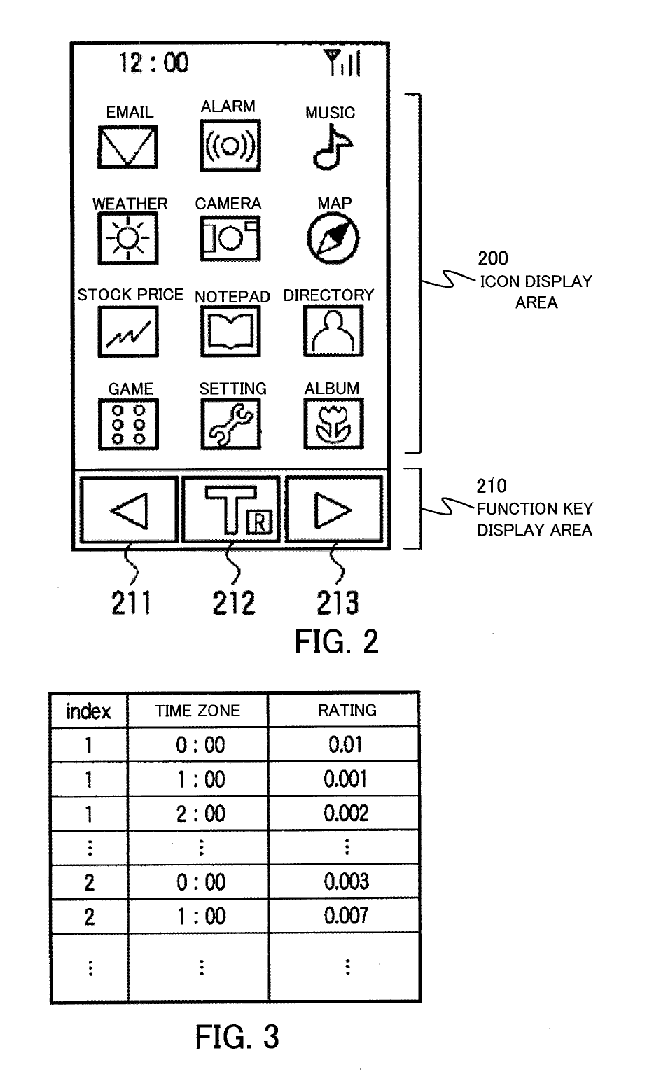

The display section 20 displays an image (static and moving), text data, etc. as directed by the controller 100 so as to visually trans-fer information to a user. As shown in FIG. 2, e.g., lots of icons corresponding to application software programs, electronic files produced by the programs, URLs (Uniform Resource Locators) of Websites, etc. are arranged and displayed in an icon display area 200, and software keys allotted some functions are displayed in a function key display area 210.

The voice communication section 30 has a speaker 31 and a microphone 32. The voice communication section 30 converts voice of a user which is input via the microphone 32 into voice data which can be processed by the controller 100, and outputs the voice data to the controller 100. The voice communication section 30 decodes voice data received from somebody who's calling via the wireless communication section 10, and outputs the decoded voice from the speaker 31.

The operation section 40 has a touch panel provided on the display section 20, as well as a plurality of key switches. The operation section 40 accepts directions from a user via the operation section 40. The touch panel can employ any one of resistive membrane, electrostatic capacitance and electromagnetic induction systems. The operation section 40 detects coordinates on the touch panel where the user operates, and notifies the controller 100 of the coordinates.

Incidentally, the controller 100 detects an icon or a function key being displayed in the display area on the display section 20 and corresponding to the coordinates notified by the operation section 40, so as to recognize an operation done on the icon or the function key. The controller 100 detects an operation such as a single click, a double click, dragging or an action by means of multiple point contact, etc., so as to recognize and carry out an order intended by the user (selection, execution, move, scaling the display up or down, scrolling, etc.).

The storage section 50 stores a control program and control data of the controller 100, application software programs, directory data including names in association with phone numbers of people to communicate with, data of sent and received emails, Web data downloaded through Web browsing and downloaded content data in memory. The storage section 50 temporarily stores streaming data, etc. in memory. The storage section 50 includes one or a plurality of memory means such as an HDD, a semiconductor memory such as a RAM or a ROM, etc.

Further, in the storage section 50, data such as excluded icon list data 50b, use history data 50c, overall rating data 50d, recommended display order data 50e and last use history data 50f are stored as control data for implementing a recommended display control described later, in addition to ordinary display order data 50a.

The ordinary display order data 50a shows, in a case where the recommended display control is not carried out, how data for identifying icons corresponding to application software programs, electronic files produced by the programs, URLs of Websites, etc. (called an icon index or just an index hereafter, shortened as index in the drawings) are arranged and displayed in the icon display area 200. Incidentally, the storage section 50 stores an icon table on which the icon index, the icon and the application software program, the electronic file or the Website URL are related to one another in memory, which is not shown in the drawings though.

The excluded icon list data 50b enumerates, in a case where the recommended display control is carried out, an icon index of an icon excluded from the recommended display control. To put it specifically, if a low priority is set to an icon index, a minimum overall rating (e.g., smaller than zero) is associated with the icon index. Meanwhile, if a high priority is set to the icon index, a maximum overall rating (e.g., 100) is associated with the icon index. The icon is thereby displayed in a later process with the low or high priority while the recommended display control is being disregarded.

As illustrated in FIGS. 3-5, the use history data 50c records use (execution) histories of respective icons. As illustrated in FIG. 3, the use history data 50c includes a time period of use management table for managing time periods of use in association with icon indices, a day of the week of use management table for managing days of the week of use in association with icon indices, and a place of use management table for managing places of use (latitude and longitude) in association with icon indices. Each of the icon indices is associated with a rating that calculation of a display priority order is based on.

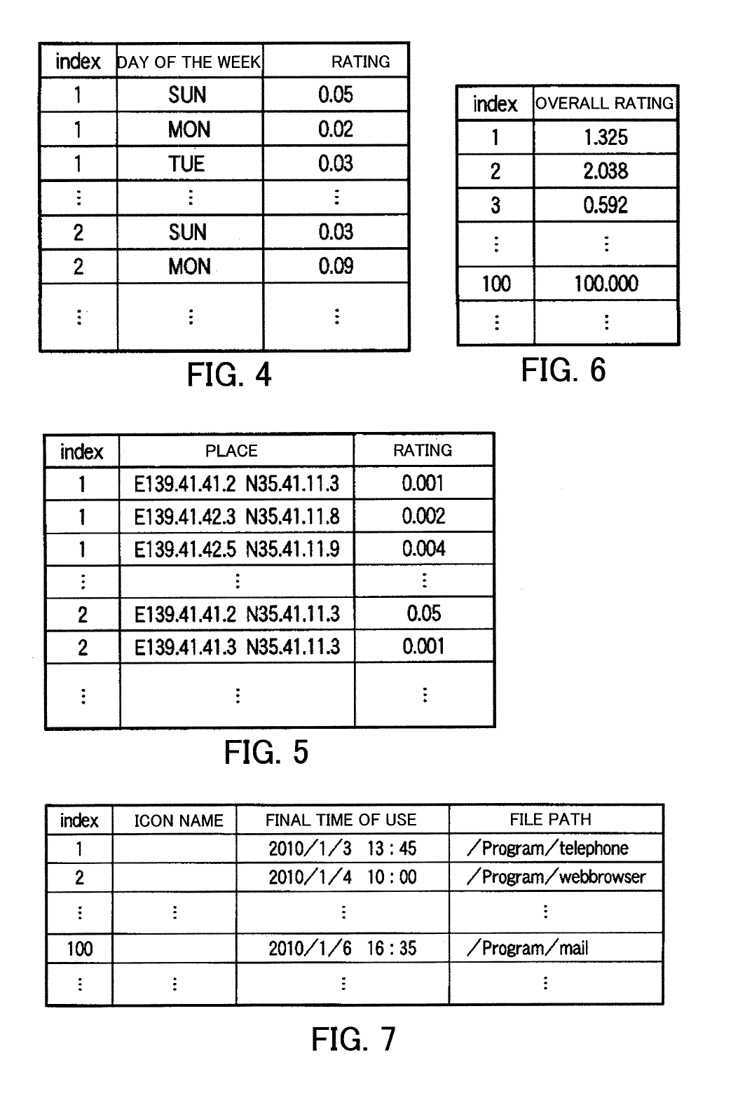

Incidentally, the time period of use is divided on a one-hour basis and the rating is managed for each of the divided time periods, as illustrated in FIG. 3. The rating can be managed, not limited to the above, but for a period of time which is shorter or longer than one hour. The rating is managed for a day of the week as illustrated in FIG. 4. The rating can be managed, not limited to the above, but for a day, a week or a month. Further, as it is expected that the place of use data does rarely agrees completely, the place of use data can be divided into areas of a proper size and can be grouped and managed in each of the areas.

The overall rating data 50d is obtained as the controller 100 uses the respective tables stored in memory as the use history data 50 overall and sums up the ratings for each of the icon indices. FIG. 6 shows an exemplary piece of the overall rating data 50d. The controller 100 sums up the ratings. The controller 100 provides the rating with some weight for each of the tables, and then sums up the weighted ratings to obtain the overall rating.

The controller 100 determines, on the basis of the overall rating data 50d, the recommended display order data 50e for indicating an order of displaying the icons. Incidentally, the ordinary display order data 50a and the recommended display order data 50e are managed independently, and the icons included in them do not need to agree with each other.

The last use history data 50f associates data indicating when the icon is last used and data indicating a file path of the icon with the icon index. FIG. 7 shows an exemplary piece of the last use history data 50f.

The broadcast receiving section 60 receives a one-segment signal included in a digital terrestrial TV broadcast signal transmitted from the broadcast station BC, and obtains broadcast data for which a video signal is encoded (encoded stream) in accordance with, e.g., an H.264 format. Although it is assumed here that the broadcast receiving section 60 receives a one-segment signal of a low frame rate, the broadcast receiving section 60 can be, not limited to the above, a digital tuner which receives a full-segment signal of a higher frame rate. Further, the broadcast station BC can be an ordinary broadcast station which services a wide area, and can be an area-limited broadcast station which services a particular receiving area such as a large-sized store or a public facility.

The GPS receiving section 70 receives GPS (Global Positioning System) signals transmitted from the GPS satellites ST1-STn so as to determine the present position (latitude, longitude, altitude), and provides the controller 100 with position data (latitude, longitude, altitude) obtained by means of the positioning process.

The digital still camera 80 photographs an object by using an image sensor such as a CCD (Charge-Coupled Device) sensor or a CMOS (Complementary Metal Oxide Semiconductor) sensor. The digital camera 80 provides the controller 100 with image data obtained by photographing as controlled by the controller 100.

The infrared ray communication section 90 performs infrared ray communication with an opposite device having an infrared ray communication function (e.g., another mobile phone MS). The controller 100 sets operation conditions to the infrared ray communication section 90. The infrared ray communication section 90 transmits transmission data provided by the controller 100 by means of an infrared ray. The infrared ray communication section 90 receives data transmitted by the opposite device by means of an infrared ray, and provides the controller 100 with the received data.

The controller 100 has a microprocessor, works in accordance with a control program and control data stored in the storage section 50, and collectively controls the respective portions of the relevant mobile communication terminal. The controller 100 has a communication control function which controls every portion of a communication subsystem so as to perform voice or data communication. The controller 100 has an application processing function which runs an email client program for making, sending and receiving emails, a browser program for Web browsing, a media reproducing program for downloading or reproducing streaming data, a broadcast receiving program for receiving a digital terrestrial TV broadcast signal transmitted from the broadcast station BC, an image processing program for photographing an object by controlling the digital still camera 80, and an image analyzing program for decoding a QR (Quick Response) code (registered trademark) by means of image analysis, and which controls the portions related to those programs.

Further, the controller 100 detects an operation done on an icon being displayed on the display section 20 on the basis of what is detected by the operation section 40. If the operation requests activation, the controller 100 carries out a function corresponding to the icon.

If, e.g., an application software program is associated with the operated icon, the controller 100 reads the application software program associated with the operated icon from the storage section 50, and runs the application software program.

Further, e.g., if an electronic file is associated with the operated icon, the controller 100 reads an application software program for using (viewing or editing) the associated electronic file from the storage section 50, and runs the application software program.

Further, e.g., if a URL of a Website is associated with the operated icon, the controller 100 activates a browser software program and starts communication via the wireless communication section 10. The controller 100 accesses a server SV in which data corresponding to the URL is stored via the Internet NW, so as to obtain Web data, etc., and to display the data on the display section 20 by using the browser software program. That is, the controller 100 accesses the URL so as to allow a user to view the data.

Then, the controller 100 has a recommended display controller 100a. This function is implemented as the controller 100 reads and runs a recommended display control application program stored in the storage section 50, so that icons are displayed in an order according to a user's history of use instead of an ordinary (while the recommended display control is inactive) order such as shown in FIG. 2.

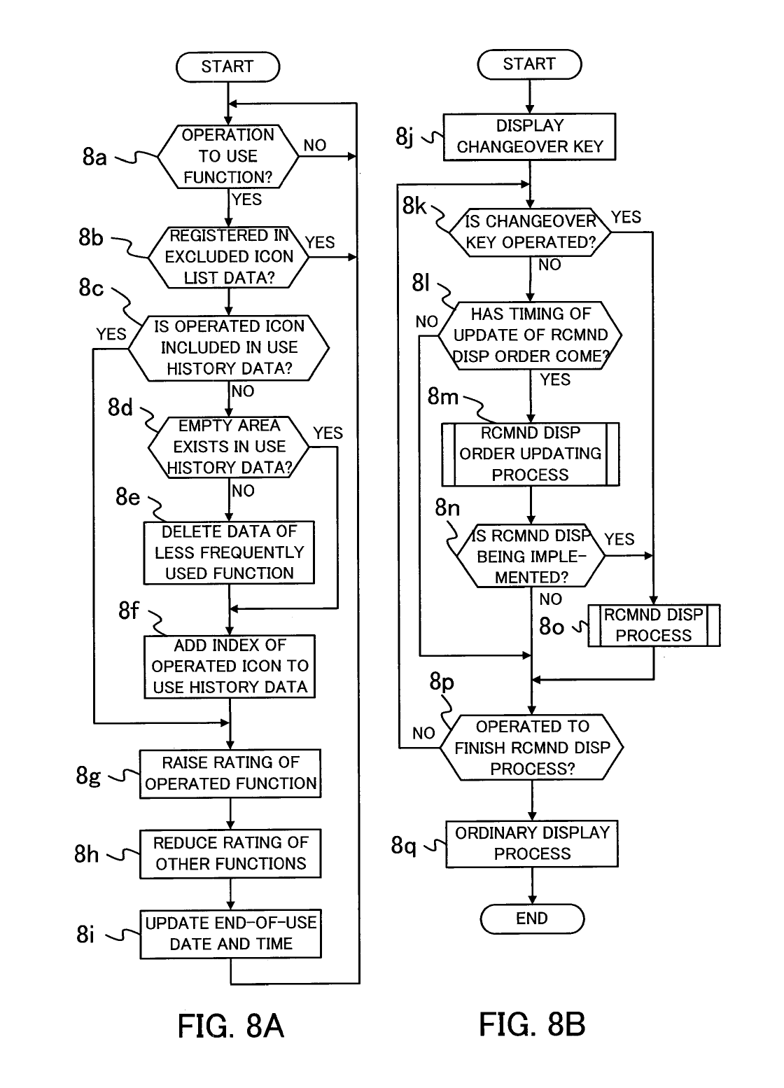

Then, an operation of the mobile communication terminal configured as described above will be explained. In particular, an operation of the recommended display control will be explained, as follows. FIGS. 8A and 8B are flowcharts for illustrating the operation of the recommended display control. First and second processes shown in FIGS. 8A and 8B, respectively, are performed in parallel.

The recommended display controller 100a implements these processes as the controller 100 reads and runs the recommended display control application program stored in the storage section 50. These processes start if a user requests the controller 100 via the operation section 40 to run the recommended display control application program.

Incidentally, before being requested to run the recommended display control application program, the controller 100 displays icons corresponding to application software programs, electronic files produced by the programs, Website URLs, etc. in accordance with an arrangement based on the ordinary display order data 50a.

The first process will be explained at first with reference to FIG. 8A. The first process is repeatedly performed until the controller 100 finishes working.

The recommended display controller 100a observes an operation done on the operation section 40 at a step 8a. The recommended display controller 100a identifies whether a user's operation (e.g., a double click) is done on an icon via the operation section 40 so that the user has acted to use a relevant function. If the action to use the function is detected, the recommended display controller 100a moves to a step 8b. Meanwhile, if no action to use the function is detected, the controller 100 returns to the step 8a for the identifying operation.

The recommended display controller 100a identifies whether the index of the icon operated at the step 8a is registered in the excluded icon list data 50b with reference to the excluded icon list data 50b at the step 8b. If the index of the operated icon is registered in the excluded icon list data 50b, the recommended display controller 100a moves to the step 8a. Meanwhile if the index of the operated icon is not registered in the excluded icon list data 50b, the recommended display controller 100a moves to a step 8c.

The recommended display controller 100a identifies whether the use history data 50c includes a table including the index of the icon operated at the step 8a with reference to the use history data 50c at the step 8c. If such a table is included, the recommended display controller 100a moves to a step 8g. If such a table is not included, the recommended display controller 100a moves to a step 8d.

The recommended display controller 100a identifies whether data of a new icon index can be added, i.e., each of the tables has an empty area, with reference to the respective tables in the use history data 50c at the step 8d. If it has such an empty area, the recommended display controller 100a moves to a step 8f. If it does not have such an empty area, the recommended display controller 100a moves to a step 8e.

The recommended display controller 100a detects an icon index estimated to have been most early used and to be less frequently used with reference to the table in the last use history data 50f at the step 8e. The recommended display controller 100a deletes data corresponding to the icon index from the respective tables so as to create an empty area, and moves to the step 8f.

Incidentally, the recommended display controller 100a is allowed to refer to the tables in the use history data 50c, to detect an icon index which appears least frequently in the tables, to delete data corresponding to the icon index from the respective tables and to create an empty area. Besides, it is conceivable that the recommended display controller 100a refers to both the last use history data 50f and the use history data 50c tables, and deletes a less frequently used icon index.

The recommended display controller 100a adds the index of the icon operated at the step 8a to the respective tables in the use history data 50c at the step 8f, and moves to the step 8g.

At the step 8g, the recommended display controller 100a raises (increases) the rating of the index of the icon operated at the step 8a, and moves to a step 8h. In the time period of use management table, e.g., the recommended display controller 100a calculates when the use of the function of the icon started on the basis of the time counted by the controller 100, and then raises the rating of the relevant time period of use included in the index of the icon operated at the step 8a.

Further, in the day of the week of use management table, the recommended display controller 100a calculates on which day of the week the use of the function of the icon started on the basis of the time counted by the controller 100, and then raises the rating of the relevant day of the week included in the index of the icon operated at the step 8a. Further, in the place of use management table, the recommended display controller 100a calculates where the use of the function of the icon started on the basis of position data acquired by the GPS receiving section 70, and then raises the rating of the relevant position included in the index of the icon operated at the step 8a.

The recommended display controller 100a reduces (decreases) a rating corresponding to an index excluding that of the icon operated at the step 8a in the respective tables of the use history data 50c at the step 8h, and moves to a step 8i.

The recommended display controller 100a calculates the start-of-use date and time of the function of the icon on the basis of the time counted by the controller 100, and records the relevant time in the last use history data 50f as the last time of use in association with the icon index at the step 8i. Then, the recommended display controller 100a moves to the step 8a. Incidentally, the recommended display controller 100a can detect end-of-use time instead of the start-of-use date and time so as to record the end-of-use time in the last use history data 50f.

Then, the second process will be explained with reference to FIG. 8B.

As shown in FIG. 2, the recommended display controller 100a displays a changeover key 212 in the function key display area 210 at a step 8j. Then, the recommended display controller 100a displays other function keys 211 and 213 such as scroll keys as well as the changeover key 212, and moves to a step 8k.

The recommended display controller 100a observes an operation done on the operation section 40 at the step 8k, and identifies whether a user's operation is done on the changeover key 212 displayed at the step 8j, i.e., the user has requested to change over to a recommended display process. If a request for the changeover to the recommended display is detected, the recommended display controller 100a moves to a step 8o. Meanwhile, if the request is not detected, the recommended display controller 100a moves to a step 8l.

At the step 8l, the recommended display controller 100a identifies whether the time for updating the recommended display order data 50c has arrived. That is, the controller 100 observes a period of time since the last update, and identifies whether the period of time has exceeded a preset value. If the time for updating has arrived, the recommended display controller 100a moves to a step 8m. Meanwhile, if the time for updating has not yet arrived, the recommended display controller 100a moves to a step 8p.

Incidentally, as shown in FIGS. 3 and 4, e.g., the identification at the step 8l is “Yes” for every period of one hour and before midnight every day, respectively. Besides, the controller 100 observes what is detected by the GPS receiving 70, and can start the process of the step 8m in cases where an existing area changes more than a particular distance, where the identification at the step 8a is “Yes”, etc.

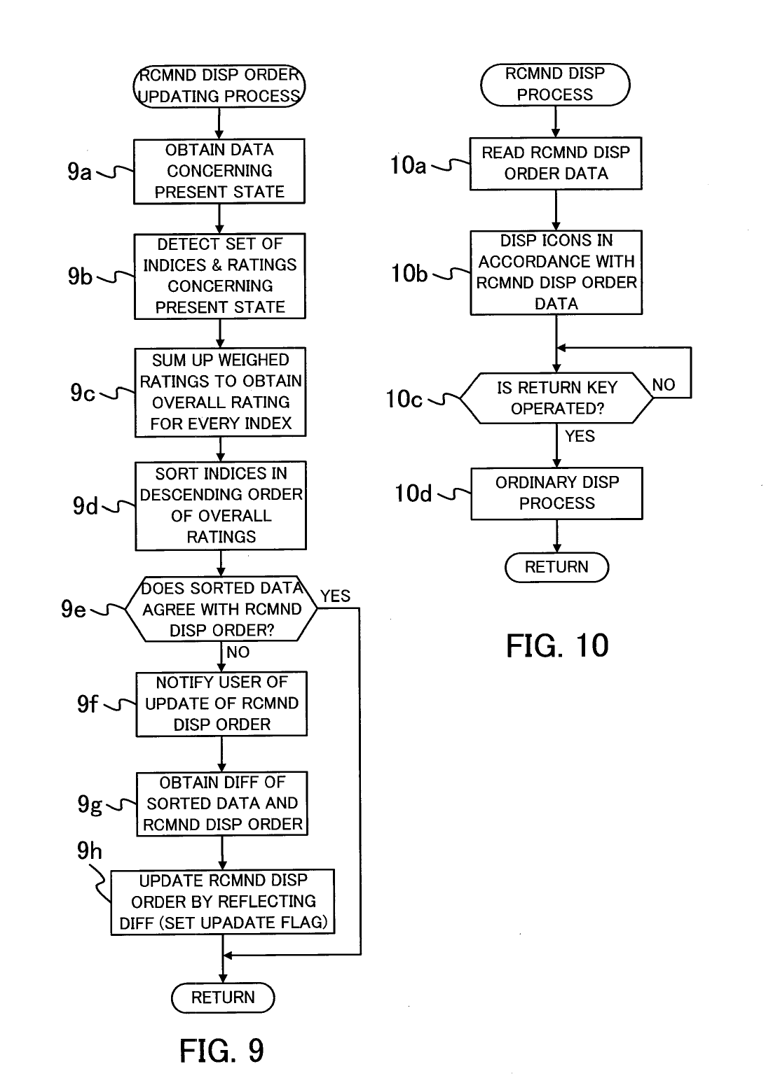

The recommended display controller 100a carries out an updating process for updating the recommended display order data 50c at the step 8m, and moves to a step 8n. The updating process will be described later in detail with reference to FIG. 9.

At the step 8n, the recommended display controller 100a identifies whether the recommended display is being implemented by means of a recommended display process at the step 8o described later. If the recommended display is being implemented at this point, the recommended display controller 100a moves to the step 8o. Meanwhile, if the recommended display is not being implemented, the recommended display controller 100a moves to the step 8p.

The recommended display controller 100a carries out the recommended display process on the basis of the recommended display order data 50e at the step 8o, and moves to the step 8p. Incidentally, the recommended display process will be described later in detail with reference to FIG. 10.

At the step 8p, the recommended display controller 100a identifies whether the user has done an operation on the operation section 40 for finishing the recommended display control application. Upon detecting a fact that the finishing operation is done, the recommended display controller 100a moves to a step 8q. Otherwise, the recommended display controller 100a moves to the step 8k.

At the step 8q, the recommended display controller 100a displays icons corresponding to application software programs, electronic files produced by the programs, Website URLs, etc. arranged in the icon display area 200 on the basis of the ordinary display order data 50a. The recommended display controller 100a then finishes the relevant process, and shifts power concerning the icon display control to the controller 100.

Then, the updating process at the step 8m will be explained with reference to FIG. 9. Although having been explained as being carried out at regular intervals, the updating process can also be carried out at times beside this interval. If the recommended display control application program is run, the recommended display controller 100a observes (detects) a system context parameter indicating a working state of the mobile communication terminal. If the parameter changes, the updating process shown in FIG. 9 is triggered by the change and carried out.

Assume, e.g., that the controller 100 detects a continuous state of no operation done on the mobile communication terminal for longer than a certain period of time, that the mobile communication terminal shifts to a hibernation (or sleeping) state, and that some of the portions shown in FIG. 1 selectively stop working so as to reduce power consumption. Even in such a state, the recommended display controller 100a is able to detect the state transition based on the above mentioned parameter, and carries out the updating process shown in FIG. 9 at regular intervals without stopping working.

The recommended display controller 100a obtains data concerning a present state at a step 9a, and moves to a step 9b. That is, the recommended display controller 100a obtains time data indicating present time from the controller 100, and obtains position data indicating a present position from the GPS receiving section 70.

The recommended display controller 100a detects a set of all the indices corresponding to the present state (present time and position data) obtained at the step 9a and ratings associated with the indices with reference to the respective tables included in the use history data 50c, and moves to a step 9c.

At the step 9c, the recommended display controller 100a provides the ratings obtained at the step 9b with weights for each of the tables, and sums up the weighted ratings for each of the indices. Then, the summed-up rating for every index and the overall rating recorded on the excluded icon list data 50b are overwritten on the overall rating data 50d and recorded. Then, the recommended display controller 100 moves to a step 9d. Incidentally, the weights can be provided in such a way that a user can preset the weights at will. If the user wants to equally handle the ratings of different tables, the user can set a same value.

The recommended display controller 100a sorts the respective overall ratings and the indices corresponding to the overall ratings in descending order of the overall ratings with reference to the data recorded in the overall rating data 50d at the step 9d, and moves to a step 9e.

At the step 9e, the recommended display controller 100a compares data sorted in the descending order of the overall ratings (the respective overall ratings and the corresponding indices) at the step 9d and the recommended display order data 50e so as to identify whether they agree with each other. If they agree with each other, the recommended display controller 100a finishes the relevant process. That is, the recommended display order data 50e is not updated. Meanwhile, if they do not agree with each other, the recommended display controller 100a moves to a step 9f.

At the step 9f, the recommended display controller 100a notifies the user of an update on the recommended display order data 50c, i.e., a change in the recommended display arrangement of the icons, and then moves to a step 9g. The recommended display controller 100a can notify the user by driving and controlling a sounder so as to produce a specific sound, by making a vibrator vibrate, by driving and controlling the display section 20 so as to display an icon indicating the update, or by displaying a message such as “arrangement of recommended display is updated”.

At the step 9g, the recommended display controller 100a compares the data sorted in the descending order of the overall ratings at the step 9d and the recommended display order data 50e so as to obtain difference data indicating a difference between them, and moves to a step 9h.

At the step 9h, the recommended display controller 100a updates the recommended display order data 50e (reflects the difference) on the basis of the difference data obtained at the step 9g, sets an update flag indicating the update and finishes the relevant process. The recommended display order data 50e is thereby updated in the order sorted at the step 9d. Incidentally, the recommended display controller 100a is allowed to set the update flag only in the hibernation (or sleeping) state.

Then, the recommended display process at the step 8o will be explained with reference to FIG. 10.

To begin with, the recommended display controller 100a reads the recommended display order data 50e at a step 10a, and moves to a step 10b.

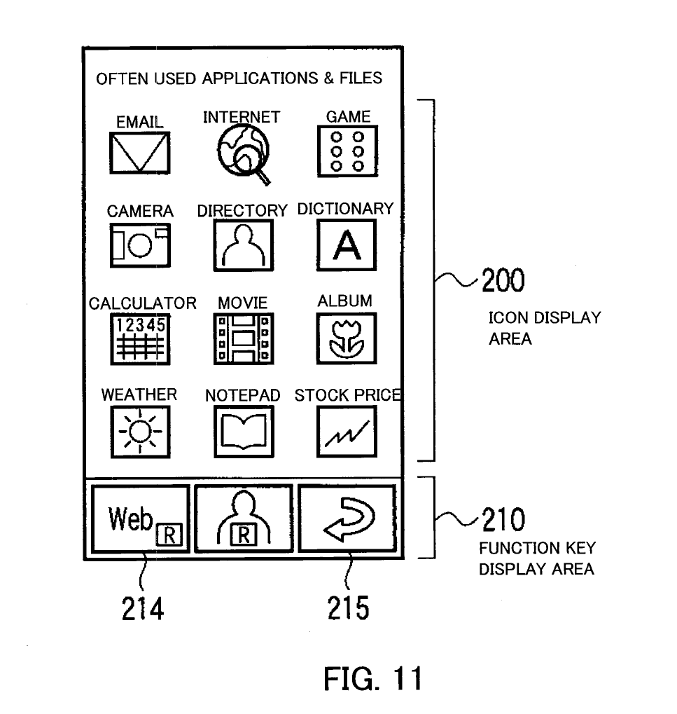

At the step 10b, the recommended display controller 100a displays an index associated with a high overall rating being given priority in the icon display area 200, and moves to a step 10c. The icons having been displayed in the arrangement, e.g., shown in FIG. 2, are thereby displayed in an order from the upper left, rightwards and then down to lower rows as shown in FIG. 11.

That is, as shown in FIG. 11, e.g., an icon shown as “email” is given the highest priority, and is followed by icons shown in an order of “Internet”, “game”, “camera”, “directory”, “dictionary”, “calculator”, . . . , “stock price” being given lower priorities. If, e.g., the menu item “email” is given a high priority in the excluded icon list data 50b and provided with a maximum overall rating, the relevant icon is displayed at a high position regardless of its frequency of use. If, conversely, the menu item is provided with a minimum overall rating, the relevant icon is displayed at a position of a low priority on one of following pages.

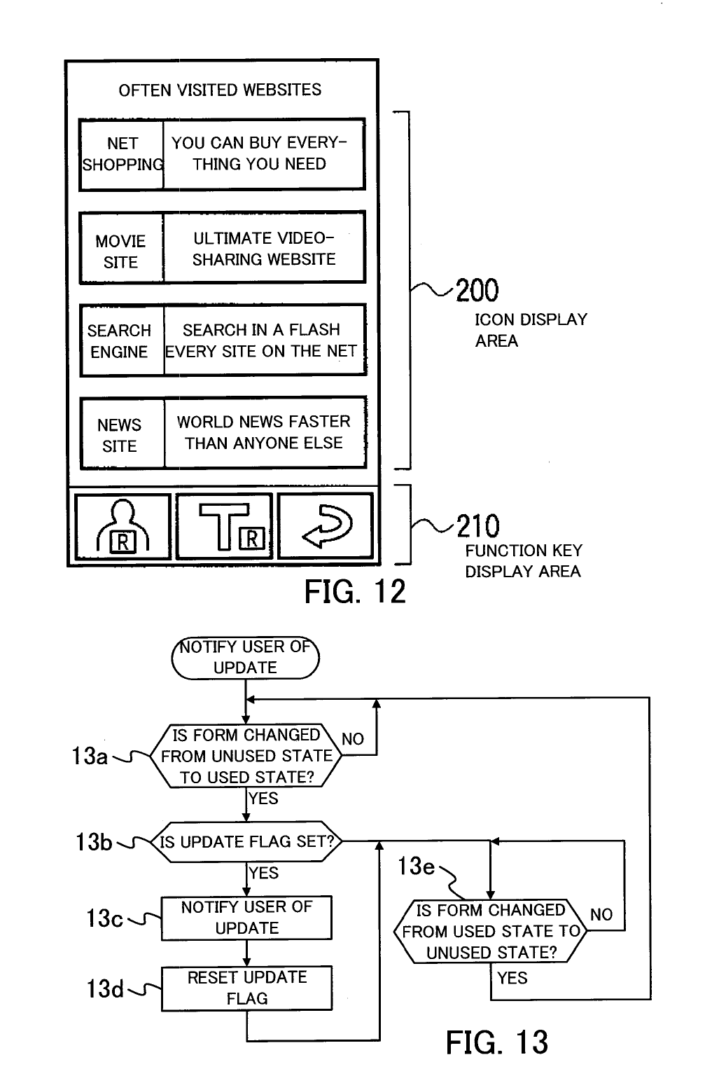

Moreover, if a user's operation is done at a position of a “Web” key 214 in the function key display area 210 as shown in FIG. 12, e.g., the recommended display controller 100a regards the “Web” key 214 as having been operated on the basis of what is detected by the operation section 40, and enumerates only icons corresponding to indices associated with Websites in the indices included in the recommended display order data 50e so as to display the enumerated icons in the icon display area 200.

In FIG. 12, e.g., titles of Websites are displayed. Instead, the controller 100 can communicate with a Website by controlling the wireless communication section 10 so as to obtain latest RSS or to extract metadata from an HTML page, and such data can be displayed. Data concerning a Website which the controller 100 has obtained by processing the title can be displayed, as well. A user can obtain latest information concerning the relevant Website at a glance.

As shown in FIG. 12, e.g., the recommended display controller 100a observes whether a user's operation is done at a position of a return key 215 in the function key display area 210 at the step 10c. At this point, if the operation is detected on the basis of what is detected by the operation section 40, the recommended display controller 100a moves to a step 10d. Meanwhile, in case of no such operation, the recommended display controller 100a continues to observe a user's operation.

At the step 10d, the recommended display controller 100a displays icons corresponding to application software programs, electronic files produced by the programs, Website URLs, etc. in the icon display area 200 in the arrangement based on the ordinary display order data 50a, then finishes the relevant process and moves to the step 8o.

Then, a process for notifying a user of an update on the recommended display order data 50e, i.e., a change in a state of recommended display arrangement of icons will be explained with reference to FIG. 13. The process will be explained as follows on the assumption that the mobile communication terminal has a mechanism to be used by the user for changing the form such as a flip type or a slide type, and has a hardware component which detects the change of the form (a switch observed by the controller 100). If the recommended display control application program is run, the process is repeatedly carried out by the recommended display controller 100a until the mobile communication terminal is powered off.

At a step 13a, at first, the recommended display controller 100a identifies whether the mobile communication terminal has changed its form from an unused state to a used state on the basis of what is observed by the controller 100. If it has changed its form to a used state, the recommended display controller 100a moves to a step 13b. Meanwhile, until it changes its form to a used state, the recommended display controller 100a will repeat the identifying process at the step 13a.

At the step 13b, the recommended display controller 100a identifies whether an update flag which is set in a case where the recommended display order data 50e is updated at the step 9h is set to the recommended display order data 50e. If the update flag is set, the recommended display controller 100a moves to a step 13c. Meanwhile, until the update flag is set, the recommended display controller 100a moves to a step 13e.

At the step 13c, the recommended display controller 100a notifies a user of an update on the recommended display order data 50e, i.e., a change in the recommended display arrangement of the icons, and then moves to a step 13d. The recommended display controller 100a can notify the user by driving and controlling a sounder so as to produce a specific sound, by making a vibrator vibrate, by driving and controlling the display section 20 so as to display an icon indicating the update, or by displaying a message such as “arrangement of recommended display is updated”.

At the step 13d, the recommended display controller 100a resets the update flag having been set to the recommended display order data 50e, and moves to the step 13e.

At the step 13e, the recommended display controller 100a identifies whether the mobile communication terminal has changed its form from a used state to an unused state. If it has changed its form to an unused state, the recommended display controller 100a moves to the step 13a. Meanwhile, until it changes its form to an unused state, the recommended display controller 100a will repeat the identifying process at the step 13e.

Incidentally, the mobile communication terminal has been explained above with reference to FIG. 13 as having a mechanism such that a user changes the form of the mobile communication terminal so as to use it. Instead, the recommended display controller 100a can identify at the step 13a whether the mobile communication terminal has changed from a hibernation (or sleeping) state to an ordinary waiting state owing to a user's operation regardless of the change of the external form, and can move to the step 13b where the mobile communication terminal has moved to the ordinary waiting state. In this case, the recommended display controller 100a identifies at the step 13e whether the mobile communication terminal has changed from the ordinary waiting state to the hibernation (or sleeping) state, and moves to the step 13a if the mobile communication terminal has changed to the hibernation (or sleeping) state.

The mobile communication terminal configured as described above stores a history of user's use of functions in memory, and controls the display arrangement of icons for using the functions on the basis of the history of use. As changing the display arrangement of icons in accordance with user's frequency of use, the mobile communication configured as described above is highly convenient for the user.

Further, the mobile communication terminal configured as described above records ratings indicating frequency as to plural conditions of use including time periods, days of the week, places, etc. The mobile communication terminal estimates a function to be probably used by a user on the basis of a rating in accordance with the present conditions (time period, day of the week, place) so as to control the display arrangement of the icons.

It is convenient for the user that the display arrangement of the icons is controlled on the basis of the present conditions and the past history of use. Further, plural conditions (time period, day of the week, place) are taken into account so that the function to be probably used by the user is estimated. Thus, even if the history of use is insufficiently piled for some conditions, the estimation can be done with reference to other conditions, so that the convenience can be prevented from being reduced.

Moreover, the mobile communication terminal configured as described above gives weights to the plural conditions piled as the history of use so as to obtain an overall rating. The mobile communication terminal estimates a function to be probably used by a user on the basis of the overall rating. Thus, as the estimation taking the weights into account can be done, more accurate performance can be provided so that the user's convenience can be enhanced.

Moreover, the mobile communication terminal configured as described above stores the excluded icon list data 50b in memory and processes an icon index stored in the excluded icon list data 50b as not being included in the objects of the recommended display control. Thus, even a function used with high frequency can be excluded from the display, or even a function used with low frequency can be given priority to be displayed.

Moreover, the mobile communication terminal configured as described above updates the recommended display order data 50e at regular intervals and if the system context parameter indicating a working state of the mobile communication terminal has changed. That is, the mobile communication terminal does not update the recommended display order data 50e after a user requests the recommended display (operates the changeover key 212). Instead, as the recommended display order data 50e is updated and the information of the display order is prepared in advance, the mobile communication terminal can shortly display the recommended display so as to save the user's stress.

Further, the recommended display order data 50e is updated by the difference data from the previous data. Thus, as there is no need to update the whole recommended display order data 50e possibly being large in data size, the mobile communication terminal can shortly update the recommended display order data 50e.

Moreover, if the recommended display order data 50e is updated, the mobile communication terminal notifies the user of the update. Thus, even if the mobile communication terminal already displays the recommended display, the user can recognize that the update is necessary.

Incidentally, the invention is not limited to the above embodiment as it is, and can be embodied by modifying the components within the scope of the invention at an implementing stage. Further, the plural components disclosed in the above embodiment can be suitably combined so that various inventions can be formed. Further, e.g., it is conceivable to remove some of the whole components disclosed in the embodiment. Further, components disclosed in different embodiments can be suitably combined.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A mobile communication terminal configured to run a plurality of application programs, comprising:
an operation section configured to be operated by a user;
a display section configured to display a plurality of icons individually corresponding to the respective programs;
a first memory in which a history of use of the programs can be stored;
a second memory in which an arrangement of the icons displayed on the display section can be stored;
an updating section configured to update the arrangement of the icons stored in the second memory on the basis of the history of use of the programs stored in the first memory; and
a display controller configured to display the icons on the display section in accordance with the arrangement stored in the second memory upon the operation section being operated by the user in a specific manner.

2. The mobile communication terminal according to claim 1, wherein the updating section updates the arrangement stored in the second memory at regular intervals.

3. The mobile communication terminal according to claim 1, further comprising an observing section configured to observe a working state of the mobile communication terminal, wherein the updating section updates the arrangement stored in the second memory upon the observing section detecting a specific working state of the mobile communication terminal.

4. The mobile communication terminal according to claim 1, further comprising a power saving section configured to make some of a plurality of functions to selectively stop working so as to save power consumption of the mobile communication terminal, wherein the updating section updates the arrangement stored in the second memory even while the power saving section is working and the power consumption is being saved.

5. The mobile communication terminal according to claim 1, wherein the updating section includes:
a first portion configured to gain an order of frequency of use of the programs on the basis of the history of use of the programs stored in the first memory;
a second portion configured to identify whether an arrangement of the icons based on the order gained by the first portion differs from the arrangement stored in the second memory; and
a third portion configured to replace the arrangement stored in the second memory with the arrangement based on the order gained by the first portion upon the second portion identifying a difference between the arrangement stored in the second memory and the arrangement based on the order gained by the first portion.

6. The mobile communication terminal according to claim 1, wherein the updating section includes:
a first portion configured to gain an order of frequency of use of the programs on the basis of the history of use of the programs stored in the first memory;
a second portion configured to gain a difference between the arrangement stored in the second memory and an arrangement based on the order gained by the first portion; and
a third portion configured to replace the arrangement stored in the second memory with the arrangement based on the order gained by the first portion on the basis of the difference gained by the second portion.

7. The mobile communication terminal according to claim 1, further comprising a notifying section which notifies the user of an update of the arrangement stored in the second memory.

8. The mobile communication terminal according to claim 7, wherein the notifying section notifies the user of the update of the arrangement stored in the second memory upon the mobile communication terminal detecting a change of a form of the mobile communication terminal.

9. The mobile communication terminal according to claim 7, wherein the notifying section notifies the user of the update of the arrangement stored in the second memory upon the mobile communication terminal detecting a change of a state of the mobile communication terminal from a hibernation state to a waiting state.

10. A method for displaying a plurality of icons on a display of a mobile communication terminal, the icons individually corresponding to a plurality of respective programs of the mobile communication terminal, comprising:
storing a history of use of the programs in a first memory of the mobile communication terminal;
storing an arrangement of the icons displayed on the display in a second memory the mobile communication terminal;
updating the arrangement of the icons stored in the second memory on the basis of the history of use stored in the first memory; and
displaying the icons on the display in accordance with the arrangement stored in the second memory upon the mobile communication terminal being operated by the user in a specific manner.

11. The method for displaying the icons according to claim 10, wherein the arrangement of the icons stored in the second memory is updated at regular intervals.

12. The method for displaying the icons according to claim 10, wherein the arrangement stored in the second memory is updated upon a specific working state of the mobile communication terminal being observed.

13. The method for displaying the icons according to claim 10, wherein the arrangement stored in the second memory is updated even while power consumption of the mobile communication terminal is being saved.

14. The method for displaying the icons according to claim 10, wherein the step of updating the arrangement of the icons stored in the second memory includes:
gaining an order of frequency of use of the programs on the basis of the history of use of the programs stored in the first memory;
identifying whether an arrangement of the icons based on the gained order of the frequency of use of the programs differs from the arrangement stored in the second memory; and
replacing the arrangement stored in the second memory with the arrangement based on the gained order of the frequency of use of the programs upon a difference being identified between the arrangement stored in the second memory and the arrangement based on the gained order of the frequency of use of the programs.

15. The method for displaying the icons according to claim 10, wherein the step of updating the arrangement of the icons stored in the second memory includes:
gaining an order of frequency of use of the programs on the basis of the history of use of the programs stored in the first memory;
gaining a difference between the arrangement stored in the second memory and an arrangement based on the gained order of the frequency of use of the programs; and
replacing the arrangement stored in the second memory with the arrangement based on the gained order of the frequency of use of the programs on the basis of the gained difference.

16. The method for displaying the icons according to claim 10, further comprising notifying the user of an update of the arrangement stored in the second memory.

17. The method for displaying the icons according to claim 16, wherein the update of the arrangement stored in the second memory is notified to the user upon the mobile communication terminal detecting a change of a form of the mobile communication terminal.

18. The method for displaying the icons according to claim 16, wherein the update of the arrangement stored in the second memory is notified to the user upon the mobile communication terminal detecting a change of a state of the mobile communication terminal from a hibernation state to a waiting state.
